(19) United States
(12) Patent Application Publication
(10) Pub. No.: US 2026/0295815 A1
(43) Pub. Date: Oct. 1, 2026

(54) TRANSMISSION MECHANISM AND ROBOT

(71) Applicant: HONDA MOTOR CO., LTD., Tokyo (JP)

(72) Inventor: Tetsuya ISHIKAWA, Saitama (JP)

(21) Appl. No.: 19/549,808

(22) Filed: Feb. 25, 2026

(30) Foreign Application Priority Data
Mar. 26, 2025 (JP) 2025-051308

(51) Int. Cl. B25J 9/10

(52) U.S. Cl. CPC B25J 9/104; B25J 9/1035

(57) ABSTRACT

Provided are a transmission mechanism and a robot equipped with the same. The transmission mechanism comprises a flexible shaft having flexibility, with an input side end to which torque is input and an output side end from which torque is output, wherein the flexible shaft has higher torsional stiffness in one rotational direction than in the other rotational direction, and transmits torque such that the joint of the robot flexes when the flexible shaft rotates in the one rotational direction.

### TECHNICAL FIELD

The present invention relates to a transmission mechanism for providing a torque transmission and a robot including the transmission mechanism.

### BACKGROUND ART

Patent Document 1 discloses a drive mechanism for a robotic hand to which rotational force from a motor is input via a reducer. In the drive mechanism of the robotic hand of Patent Document 1, the rotational force from the motor is transmitted to an input shaft element of the reducer via a flexible shaft having an outer periphery covered with a guide tube G.

### PRIOR ART DOCUMENT(S)

### Patent Document(s)

Patent Document 1: JP5301934B

### SUMMARY OF THE INVENTION

### Task to Be Accomplished by the Invention

A robotic hand, which is shaped in a way that resembles a human hand, is generally configured to flex its finger portions to grasp an object and extend them to release the object.

For example, when a robotic hand grasps an object placed on a desk, in some cases, a load that resists its flexion operation is applied to finger portions thereof from the object or the desk. Such a load can hinder the operation of a drive mechanism for flexing the robotic hand. This results in a risk that a load will be applied to the drive mechanism or transmission mechanism that conveys the drive mechanism's output to the finger portions.

Each finger portion has one or more joints for flexion and extension. In one possible configuration, a motor may be placed at each of the joints as a drive power source. However, such a configuration prevents a robotic hand from being made small.

In view of this problem, the present inventor attempted to configure a robotic hand to include a drive power source for outputting bidirectional torque placed at a position away from a joint, and a flexible shaft for transmitting the output from the drive power source to the joint. During this attempt, the inventor has found that torsional stiffness of the flexible shaft can depend on the direction of input torque.

The present invention has been made based on the inventor's findings described above, and a primary object of the present invention is to provide a transmission mechanism for transmitting torque from a drive device to a joint and a robot equipped with the same, in which the joint flexes and extends in response to bidirectional torque output by the drive device, the transmission mechanism being configured to utilize torsional stiffness characteristics of a flexible shaft that vary depending on the input torque, to reduce the negative effect of a load that hinders the robot's flexing operation.

### Means to Accomplish the Task

As a solution to the above-described task to be accomplished, an aspect of the present invention provides a transmission mechanism which transmits torque from a drive device to a joint of a robot such that the joint flexes and extends in response to bidirectional torque output by the drive device, the transmission mechanism comprising a flexible shaft having flexibility, with an input side end to which torque is input and an output side end from which torque is output, wherein the flexible shaft has lower torsional stiffness in one rotational direction than in the other rotational direction, and transmits torque such that the joint of the robot flexes when the flexible shaft rotates in the one rotational direction.

As a solution to the above-described task to be accomplished, another aspect of the present invention provides a robot with a joint, the robot comprising: a drive device that outputs bidirectional torque to flex and extend the joint; a displacement mechanism that flexes the joint when torque in one rotational direction is input from the drive device; and a flexible shaft that connects the displacement mechanism to the drive device, wherein the flexible shaft comprises a plurality of winding layers formed by the winding of element wires in opposite winding directions alternately in consecutive layers, and wherein the element wire forming the outermost layer of the flexible shaft is wound in the same direction as the other rotational direction.

As a solution to the above-described task to be accomplished, yet another aspect of the present invention provides a robot with first and second joints, the robot comprising: a first drive device that outputs bidirectional torque to flex and extend the first joint; a second drive device that outputs bidirectional torque to flex and extend the second joint; a first displacement mechanism that flexes the first joint when torque in one rotational direction is input from the first drive device; a second displacement mechanism that flexes the second joint when torque in the other rotational direction is input from the second drive device; a first flexible shaft that connects the first displacement mechanism to the first drive device; and a second flexible shaft that connects the second displacement mechanism to the second drive device, wherein each of the first flexible shaft and the second flexible shaft comprises a plurality of winding layers formed by the winding of element wires in opposite winding directions alternately in consecutive layers, wherein the element wire forming the outermost layer of the first flexible shaft is wound in the same direction as the other rotational direction, and wherein the element wire forming the outermost layer of the second flexible shaft is wound in the same direction as the one rotational direction.

### Effect of the Invention

According to the above-described aspects of the present invention, in the transmission mechanism and the robot equipped with the same, in which the transmission mechanism transmits torque from a drive device to a joint such that the joint flexes and extends in response to bidirectional torque output by the drive device, torsional stiffness characteristics of a flexible shaft that vary depending on the direction of the input torque, can be utilized to reduce the negative effect of an impact force that can be applied to the robot.

### BRIEF DESCRIPTION OF THE DRAWINGS

FIG. 1 is a side view of a robot equipped with a transmission mechanism of an embodiment of the present invention, the robot being in its extended state;

FIG. 2 is a top view of a robot equipped with a transmission mechanism of the embodiment of the present invention, the robot being in its extended state;

FIG. 3 is a side view of a robot equipped with a transmission mechanism of the embodiment of the present invention, the robot being in its flexed state;

FIG. 4A includes an enlarged view of an area enclosed by a dashed line in FIG. 2 and explanatory diagrams showing the winding directions of an inner shaft inside a flexible shaft;

FIG. 4B is an enlarged view of an area B in FIG. 4A;

FIG. 4C is an enlarged view of an area C in FIG. 4A;

FIG. 5A is a diagram showing a flexible shaft having an inner shaft in which an element wire forming the outermost layer thereof is wound clockwise;

FIG. 5B is a graph showing torsional stiffness characteristics of the flexible shaft shown in FIG. 5A;

FIG. 6A is a diagram showing a flexible shaft having an inner shaft in which an element wire forming the outermost layer thereof is wound counterclockwise;

FIG. 6B is a graph showing torsional stiffness characteristics of the flexible shaft shown in FIG. 6A; and

FIG. 7 is a table showing combinations of screw shaft directions and element wire winding directions that can achieve high torsional stiffness during flexion when a first connection mechanism and a second connection mechanism shown in FIG. 1 are used.

### DESCRIPTION OF THE PREFERRED EMBODIMENT(S)

Embodiments of a transmission mechanism and a robot including the transmission mechanism according to the present invention will be described with reference to the appended drawings.

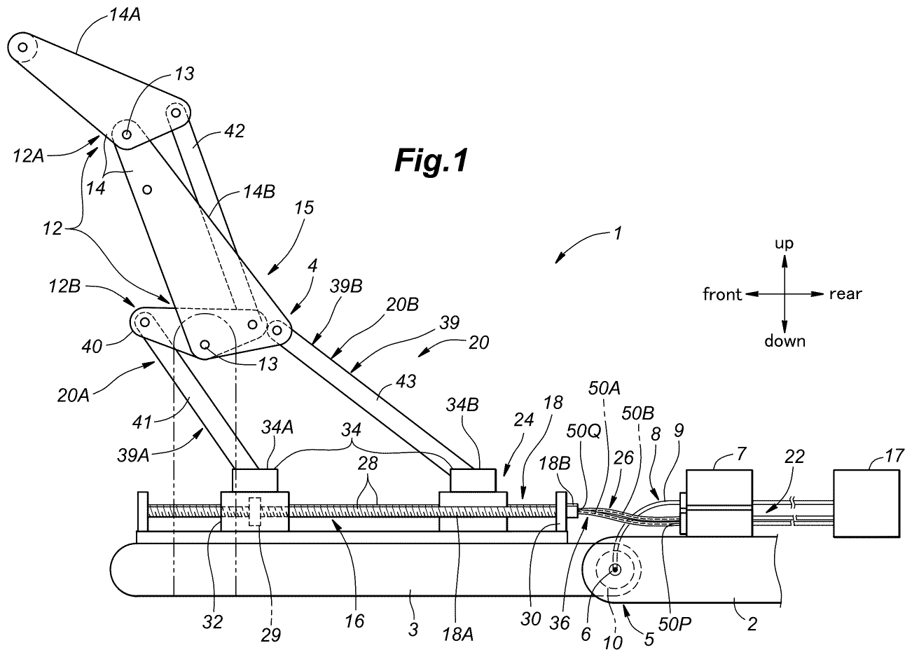

A robot 1 according to the present invention is what is called a multi-joint robot, and in the present embodiment, the robot 1 is a human-type robot (humanoid robot) that forms a human arm portion from the forearm to the fingertip. FIG. 1 shows a schematic diagram of a configuration of the robot 1 according to an embodiment of the present invention. However, FIG. 1 shows only an exemplary configuration, and embodiments of the present invention are not limited thereto.

### Configuration of Robot

As shown in FIG. 1, a robot 1 according to one embodiment of the present invention includes a forearm portion 2, a palm portion 3 connected to the forearm portion 2, and a finger portion 4 connected to the palm portion 3. The forearm portion 2 forms a part corresponding to a human forearm. The palm portion 3 is connected to the forearm portion 2 at its proximal end and forms a part corresponding to a human palm. The finger portion 4 is connected to the palm portion 3 at its proximal end and forms a part corresponding to a human finger. For simplicity, the following description is made with reference to the embodiment in which the single finger portion 4 is connected to the palm portion 3. However, the present invention is not limited to this number of the finger portion 4 on this palm portion 3, and two or more finger portions 4 may be connected to the palm portion 3.

The palm portion 3 is connected to the forearm portion 2 via a wrist joint 5. The wrist joint 5 includes a wrist joint shaft 6, which serves as a rotational axis.

The forearm portion 2 includes a palm drive device 7 for driving the palm portion 3 for relative rotation thereof to the forearm portion 2, and a palm transmission mechanism 8 for transmitting power output from the palm drive device 7 to the wrist joint 5.

The palm drive device 7 includes an electric motor equipped with an output shaft that generates torque. A palm transmission mechanism 8 includes a flexible shaft 9 connected to the output shaft and a reducer 10 positioned between the shaft 9 and the wrist joint 5.

The finger portion 4 comprises a link mechanism 15 including a plurality of links 14 connected to each other via joint 12.

In the present embodiment, as shown in FIG. 1, the finger portion 4 includes, as the links 14, a first link 14A and a second link 14B connected in series in order from the free end (distal end) side. The finger portion 4 further includes, as the joints 12, a first joint 12A and a second joint 12B in order from the free end side.

The first link 14A is connected to the second link 14B via the first joint 12A. The second link 14B is connected to the palm portion 3 via the second joint 12B. The first joint 12A and the second joint 12B are each formed primarily by a joint shaft 13 that forms a rotational axis. In FIG. 1, part of the palm portion 3 is depicted by a dashed line in order to illustrate the structure of the finger portion 4.

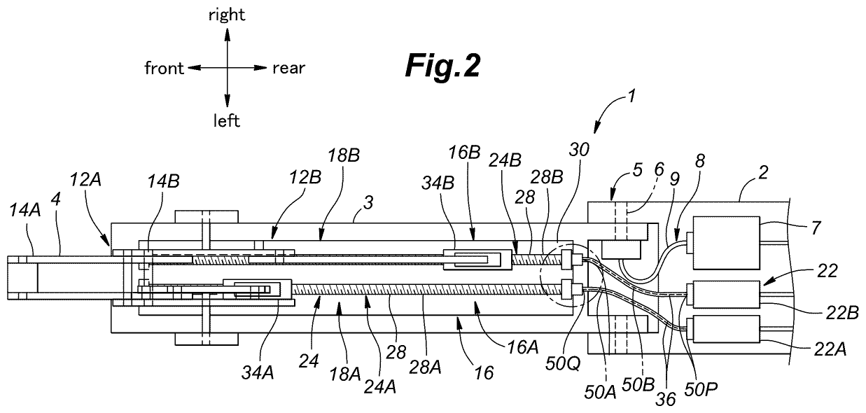

In the following description, unless otherwise specified, terms front, rear, left, right, up and down indicate directions defined relative to the robot 1 in its extended state (as shown in FIGS. 1 and 2), as represented by Arrows in FIG. 1. It should be noted that expressions indicating these directions are used herein for the sake of convenience in the description, but not for the purpose of limiting the directions in embodiments of the present invention. As shown in FIG. 1, the joint shaft 13 of the first joint 12A and that of the second joint 12B are substantially parallel with each other and extend in the left-right direction.

### Drive Mechanism and Control Device

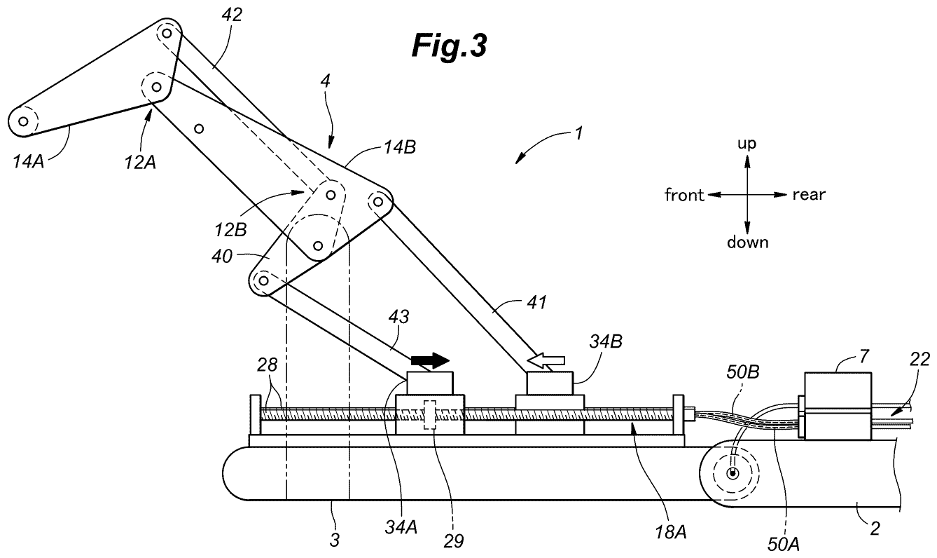

The robot 1 includes drive mechanisms 16 and a control device 17. The drive mechanisms 16 are configured to displace the finger portion 4 between a state in which the finger portion 4 is extended (hereinafter referred to as “extended state”; FIGS. 1 and 2) and a state in which the finger portion 4 is flexed (hereinafter referred to as “flexed state”; FIG. 3), thereby flexing and extending the finger portion 4. The control device 17 is configured with a computer including a processor, a memory, a storage, and other elements and controls the robot 1.

As shown in FIG. 1, the robot 1 includes, as the drive mechanisms 16, a first drive mechanism 16A and a second drive mechanism 16B. The first drive mechanism 16A flexes and extends the finger portion 4 at the first joint 12A, while the second drive mechanism 16B flexes and extends the finger portion 4 at the second joint 12B.

The first drive mechanism 16A and the second drive mechanism 16B each include a linear actuator 18 and a connection mechanism 20 that connects the linear actuator 18 to the corresponding links 14.

In the following description, the linear actuator 18 of the first drive mechanism 16A is referred to as a first linear actuator 18A, and the linear actuator 18 of the second drive mechanism 16B is referred to as a second linear actuator 18B. The first linear actuator 18A and the second linear actuator 18B, which have a similar configuration, are collectively referred to as the linear actuators 18.

Each of the linear actuators 18 includes a drive device 22 that outputs bidirectional torque, a ball screw mechanism 24 that converts the output from the drive device 22 into linear motion, and a transmission mechanism 26 that transmits the torque output by the drive device 22 to the ball screw mechanism 24.

Each of the drive devices 22 consists primarily of an electric motor connected to the control device 17. Each drive device 22 outputs bidirectional torque (clockwise and counterclockwise) to its output shaft according to signals from the control device 17.

Each of the ball screw mechanisms 24 includes a screw shaft 28, a nut 29, balls (not shown), and a casing body 30 that rotatably supports the screw shaft 28. Rotating one end (hereinafter referred to as the input end) of the screw shaft 28 causes the nut 29 to move along the axis of the screw shaft 28 in the longitudinal direction thereof.

In the present embodiment, for each of the ball screw mechanism 24, a slider housing 32 is coupled to the nut 29, and a slider 34 is configured with the slider housing 32 and the nut 29. In the following description, the terms first slider 34A and second slider 34B are also used to refer to the slider 34 of the first linear actuator 18A and the slider 34 of the second linear actuator 18B, respectively, when necessary.

When a thread of the screw shaft 28 runs in a clockwise direction as viewed from its input end (i.e., right-handed screw thread) and the input end is rotated clockwise (viewed from the input end), the screw shaft 28 is tightened with respect to the nut 29. In other words, the nut 29 moves toward the input end of the screw shaft 28. Conversely, when a thread of the screw shaft 28 runs in a clockwise direction (as viewed from the input end) and the input end is rotated counterclockwise (viewed from the input end), the nut 29 moves away from the input end of the screw shaft 28.

When a thread of the screw shaft 28 runs in a counterclockwise direction as viewed from its input end (i.e., left-handed screw thread) and the input end is rotated counterclockwise (viewed from the input end), the screw shaft 28 is tightened with respect to the nut 29. In other words, the nut 29 moves toward the input end of the screw shaft 28. Conversely, when a thread of the screw shaft 28 runs in a counterclockwise direction (as viewed from the input end) and the input end is rotated clockwise (viewed from the input end), the nut 29 moves away from the input end of the screw shaft 28.

In the following description, with regard to the direction in which the nut 29 of each of the first drive mechanism 16A and second drive mechanism 16B moves along an extending direction of the corresponding screw shaft 28, the direction in which the nut 29 moves toward the input end (the rearward direction in FIG. 1) is referred to as a “negative direction”, whereas the direction in which the nut 29 moves away from the input end (the frontward direction in FIG. 1) is referred to as a “positive direction.”

In the present embodiment, the ball screw mechanism 24 of the first drive mechanism 16A (hereinafter referred to as a first ball screw mechanism 24A) and the ball screw mechanism 24 of the second drive mechanism 16B (hereinafter referred to as a second ball screw mechanism 24B) are identical in shape. The first ball screw mechanism 24A and the second ball screw mechanism 24B are arranged side by side to extend in parallel with each other, and are supported by the palm portion 3

When the input ends of the first ball screw mechanism 24A and the second ball screw mechanism 24B are rotated in the same direction, the corresponding nuts 29 move in the same direction along the extending direction of the screw shafts 28.

Each of the transmission mechanisms 26 includes a shaft unit 36. The shaft unit 36 connects the drive device 22 to the corresponding screw shaft 28. The shaft unit 36 transmits the rotation of the output shaft of the drive device 22 to the corresponding screw shaft 28, causing the screw shaft 28 to rotate.

When the output shaft of each drive device 22 rotates, the corresponding screw shaft 28 rotates, causing the nut 29 thereon to move along the extending direction of the screw shaft 28. As a result, the corresponding slider 34 slides along the extending direction of the screw shaft 28.

The connection mechanisms 20 are each provided between the corresponding nut 29 and the link(s) 14, converting the movement of the nuts 29 in the ball screw mechanisms 24 into the flexing motion of the finger portion 4. In the present embodiment, each of the connection mechanisms 20 connects the corresponding slider 34, which includes the nuts 29, to the link(s) 14.

For each of the drive mechanisms 16, the connection mechanism 20 and the ball screw mechanism 24 form a displacement mechanism 39 that can flex the corresponding joint 12 when torque is input from the corresponding drive device 22. Specifically, for the first drive mechanism 16A, the connection mechanism 20 therein (hereinafter referred to as a first connection mechanism 20A) and the first ball screw mechanism 24A form a first displacement mechanism 39A that flexes the first joint 12A when torque is input from the first drive device 22A. For the second drive mechanism 16B, the connection mechanism 20 therein (hereinafter referred to as a second connection mechanism 20B) and the second ball screw mechanism 24B form a second displacement mechanism 39B that flexes the second joint 12B when torque is input from the second drive device 22B.

The first connection mechanism 20A includes a reverser plate 40 (also referred to as a lever), a first rod 41, and a second rod 42.

The reverser plate 40 is rotatably supported at its central part for relative rotation to the palm portion 3 around an axis extending in the left-right direction. The first rod 41 is rotatably connected at one end to the first slider 34A for rotation around an axis extending in the left-right direction. The first rod 41 is rotatably connected at its other end to one end of the reverser plate 40 for rotation around an axis extending in the left-right direction.

The second rod 42 is rotatably connected at one end to the other end of the reverser plate 40 for rotation around an axis extending in the left-right direction. The second rod 42 is rotatably connected at its other end to the first link 14A for rotation around an axis extending in the lateral direction.

When the first slider 34A moves in the negative direction (rearward), one end of the first rod 41 is pushed downward. This causes the reverser plate 40 to rotate, pushing up the other end of the second rod 42, rotating the first link 14A, and causing the finger portion 4 to flex at the first joint 12A. Conversely, when the first slider 34A moves in the positive direction (frontward), the finger portion 4 is extended at the first joint 12A.

The second connection mechanism 20B includes a third rod 43. The third rod 43 is rotatably connected at one end to the second slider 34B for rotation around an axis extending in the left-right direction. The third rod 43 is rotatably connected at the other end to the second link 14B for rotation around an axis extending in the left-right direction.

When the second slider 34B moves in the positive direction (frontward), one end of the third rod 43 is pushed upward. This pushes the second link 14B upward, causing the finger portion 4 to flex at the second joint 12B. Conversely, when the second slider 34B moves in the negative direction (rearward), the finger portion 4 is extended at the second joint 12B.

In this way, when the first slider 34A moves in the negative direction (see a black arrow in FIG. 3) and the second slider 34B moves in the positive direction (see a white arrow in FIG. 3), the finger portion 4 flexes at the first joint 12A and the second joint 12B, respectively. As a result, the finger portion 4 is displaced toward the flexed state.

When the first slider 34A moves in the positive direction and the second slider 34B moves in the negative direction, the finger portion 4 extends at both the first joint 12A and the second joint 12B. As a result, the finger portion 4 is displaced toward the extended state.

### Shaft Unit

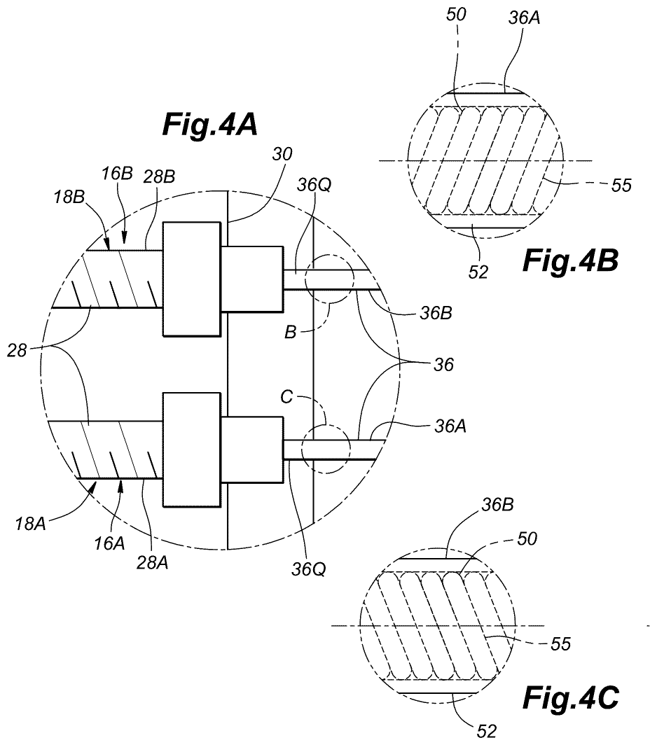

Next, the structure of each of the shaft unit 36 will be described. As shown in FIGS. 4A to 4C, the shaft unit 36 each includes a flexible shaft 50 and an outer tube 52.

Each of the flexible shafts 50 has a linear shape extending along its longitudinal axis. The flexible shaft 50 has flexibility and is capable of bending deformation. Each of the flexible shafts 50 is produced by arranging several element wires 55 composed of steel rod (wire) or any other suitable wire rod in a strip-like manner on a single bendable core wire 54 (core rod), and winding them in a direction forming a predetermined pitch angle relative to the axis to form a first winding layer 56, and then repeating the similar process, i.e., arranging several element wires 55 in a strip-like manner and winding them in the opposite direction to the previous layer to thereby form subsequent winding layers 56 (i.e., second and third winding layers). In the present embodiment, each flexible shaft 50 has two winding layers 56.

Each outer tube 52 is formed as a cylindrical member with an inner bore through which the flexible shaft 50 is inserted. The outer tube 52 is formed from a plastic member or any suitable material, and similarly to the flexible shaft 50, is capable of bending deformation. Each flexible shaft 50 is slidably inserted into the inner bore of the corresponding outer tube 52. Thus, the flexible shaft 50 is also referred to as the “inner shaft.” The outer tubes 52 protect the flexible shafts 50 from dust and moisture.

Each of the flexible shafts 50 is connected at its one end (input side end 50P) to the output shaft of the corresponding drive device 22, with torque being input to its input side end 50P (FIGS. 1 and 2). The flexible shaft 50 is connected at the other end (output side end 50Q) to the screw shaft 28 of the corresponding ball screw mechanism 24, outputting torque at the output side end 50Q (FIGS. 1 and 2). Thus, the flexible shaft 50 transmits the rotation of the output shaft of the drive device 22 to the corresponding screw shaft 28, causing the screw shaft 28 to rotate.

### Torsional Stiffness Characteristics

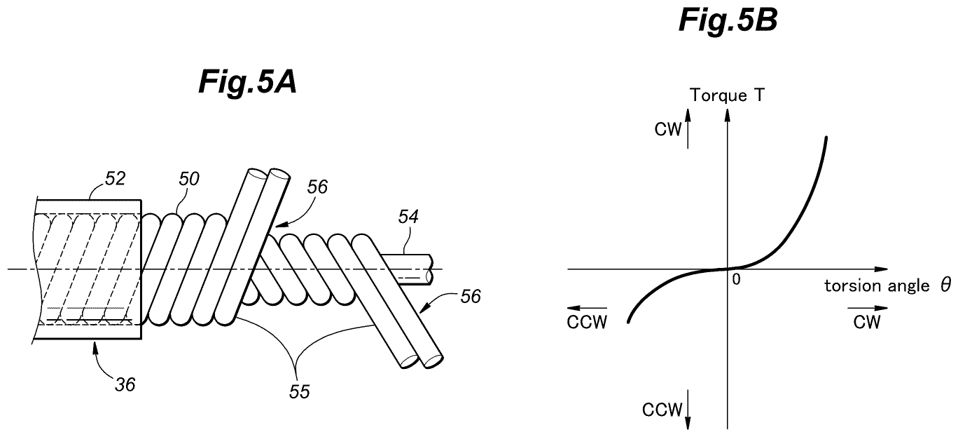

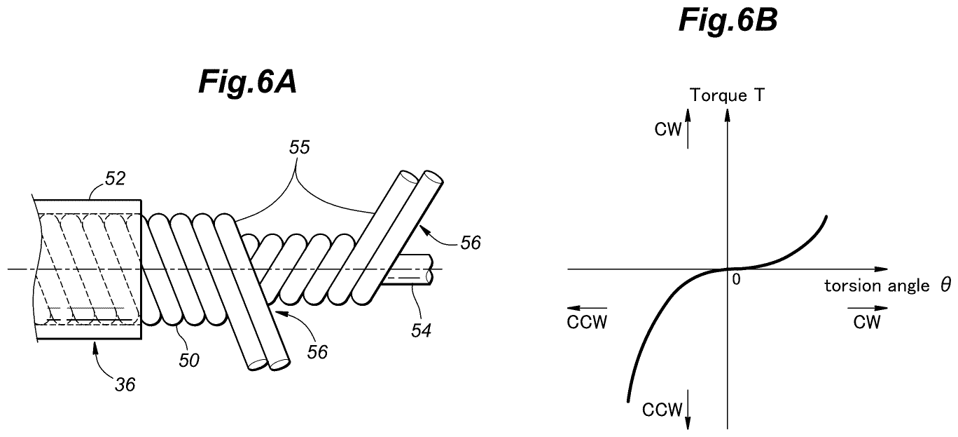

The present inventor has found that the characteristics of the flexible shaft 50 depend on the winding direction of the element wire 55 thereof. The relationship between the winding direction of the element wire 55 and the characteristics of the flexible shaft 50 will be described with reference to FIGS. 5A, 5B, 6A and 6B. In the following description, the winding direction of an element wire 55 refers to the winding direction of the element wire 55 as viewed from one end of the flexible shaft on the side of the output of the drive device 22.

FIGS. 5A and 5B illustrate torsional stiffness characteristics of the flexible shaft 50 (characteristic diagram), in particular showing the relationship between the torsion angle θ of the flexible shaft 50 and the torque T acted on one end of the shaft, when the winding direction of the element wire 55 is clockwise. In FIGS. 5A and 5B, the torsion angle θ is defined as positive when it is formed by the rotation in the clockwise direction.

As shown in FIGS. 5A and 5B, when the winding direction of the element wire 55 is clockwise, the amount of change in torque T with respect to torsion angle θ (|dT/dθ|) is greater when torque is applied in the clockwise direction compared to when the counterclockwise torque is applied. In particular, the difference in the change in torque T with respect to torsion angle θ due to the rotational direction becomes more significant when a relatively large torque is applied.

Specifically, when the winding direction of the element wire 55 is clockwise, applying a relatively large torque in the clockwise rotational direction results in a greater change in torque T relative to the torsion angle θ compared to applying torque in the counterclockwise rotational direction, thereby increasing torsional stiffness. This is because, when the winding direction of the element wire 55 is clockwise, applying clockwise torque causes the element wire 55 in the outermost layer to be tightened and come into contact with the element wire 55 in the inner layer, which contact creates a contact load between the element wire 55 in the outermost layer and the element wire 55 in the inner layer.

FIGS. 6A and 6B illustrate torsional stiffness characteristics of the flexible shaft 50 (characteristic diagram), in particular showing the relationship between the torsion angle θ of the flexible shaft 50 and the torque T acted on one end of the shaft, when the winding direction of the element wire 55 is counterclockwise. In FIGS. 6A and 6B, the torsion angle θ is defined as positive when it is formed by the rotation in the clockwise direction.

As shown in FIGS. 6A and 6B, when the winding direction of the element wire 55 is counterclockwise, the amount of change in torque T with respect to torsion angle θ (|dT/dθ|) is greater when torque is applied in the counterclockwise direction compared to when the clockwise torque is applied. In particular, the difference in the change in torque T with respect to torsion angle θ due to the rotational direction becomes more significant when a relatively large torque is applied.

Specifically, when the winding direction of the element wire 55 is counterclockwise, applying a relatively large torque in the counterclockwise rotational direction results in a greater change in torque T relative to the torsion angle θ compared to applying torque in the clockwise rotational direction, thereby increasing torsional stiffness. This is because, when the winding direction of the element wire 55 is counterclockwise, applying counterclockwise torque causes the element wire 55 in the outermost layer to be tightened and come into contact with the element wire 55 in the inner layer, which contact creates a contact load between the element wire 55 in the outermost layer and the element wire 55 in the inner layer.

### Winding Direction of Flexible Shaft

When the robot 1 grasps an object placed on the desk, in some cases, the finger portion 4 can come into conflict with the object on the desk or with the desk itself, causing a collision load to be applied to the finger portion 4 in such a direction that hinders the flexing operation thereof. In this case, a load can also be applied to the nut 29 to hinder its movement required for the flexing operation of the finger portion 4, resulting in a risk that a load will be applied to the output shaft of the drive device 55 via the flexible shaft 50.

The present inventor has found that, on the strength of the findings that the torsional stiffness of the flexible shaft 50 depends on the direction of the input torque, an impact load caused by collision can be absorbed by properly determining the winding direction of the element wire 55 of the flexible shaft 50 based on the direction in which the thread of the screw shaft 28 runs.

FIGS. 4A to 4C show one example of a configuration (Example 1) that can absorb an impact load caused by collision.

As shown in FIGS. 4A to 4C, the screw shaft 28 of the first drive mechanism 16A (first screw shaft 28A) is configured with a right-hand screw thread. In the flexible shaft 50 of the first drive mechanism 16A (hereinafter referred to as a first flexible shaft 50A), the winding direction of the element wire 55 in the outermost layer is determined to be counterclockwise.

To flex the first joint 12A requires the movement of the first slider 34A in the negative direction (rearward). Since the screw shaft 28 of the first drive mechanism 16A is configured with a right-hand screw thread, the output shaft of the first drive device 22A needs to rotate clockwise. As shown in FIGS. 4A to 4C, determining the winding direction of the element wire 55 of the outermost layer of the flexible shaft 50 to be counterclockwise allows for a lower torsional stiffness of the flexible shaft 50 compared to when the winding direction is clockwise.

As shown in FIGS. 4A to 4C, the screw shaft 28 of the second drive mechanism 16B (first screw shaft 28B) is configured with a right-hand screw thread. In the flexible shaft 50 of the second drive mechanism 16B (hereinafter referred to as a second flexible shaft 50B), the winding direction of the element wire 55 in the outermost layer is determined to be clockwise.

To flex the second joint 12B requires the movement of the second slider 34B in the positive direction (frontward). Since the screw shaft 28 of the second drive mechanism 16B is configured with a right-hand screw thread, the output shaft of the second drive device 22B needs to rotate counterclockwise. As shown in FIGS. 4A to 4C, determining the winding direction of the element wire 55 of the outermost layer of the flexible shaft 50 to be clockwise allows for a lower torsional stiffness of the flexible shaft 50 compared to when the winding direction is counterclockwise.

When a load is applied to the finger portion 4 so as to hinder the flexing operation of the finger portion 4, the flexible shaft 50 is twisted by the output of the drive device 22. Since, for each of the first drive mechanism 16A and the second drive mechanism 16B, the rotational direction of the corresponding drive device 22 is set to the direction that achieves a lower torsional stiffness of the flexible shaft 50 during the flexing operation, when a load is applied to the finger portion 4 in such a direction that hinders the flexing operation thereof, the flexible shaft 50 is twisted to the rotational direction that achieves a lower torsional stiffness. Thus, compared to when the rotational direction of the drive device 22 is set to the direction that achieves a higher torsional stiffness of the flexible shaft 50 during the flexing operation, the above setting of the rotational direction enables the flexible shaft 50 to be deformed more easily, thereby achieving the good absorption of the load. Accordingly, the above configuration can provide the transmission mechanism 26 and the robot 1 configured to utilize the torsional stiffness characteristics of the flexible shaft 50 that vary depending on the direction of the input torque.

Generally, when the torsional stiffness of the flexible shaft 50 during the flexing operation is high, a high force control performance is required for the robot 1 to grasp a soft object or attempts to grasp an object softly. In the present embodiment, since the finger portion 4 is configured to flex when the flexible shaft 50 rotates in a direction that achieves a lower torsional stiffness, the robot can grasp a soft object or grasp an object mechanically softly without requiring a high force control performance.

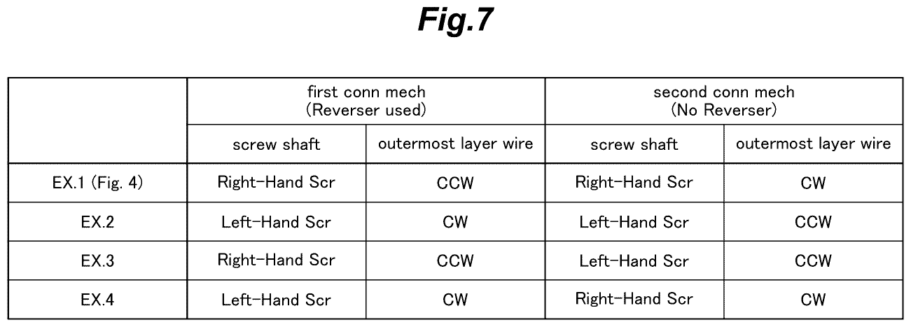

FIG. 7 is a table showing combinations (Examples 1 to 4) of screw shaft directions and element wire winding directions that can achieve lower torsional stiffness during flexion when the first connection mechanism 20A and the second connection mechanism 20B shown in FIG. 1 are used. Example 1 in FIG. 7 corresponds to the example shown in FIGS. 4A to 4C.

As shown in FIG. 3, a reverser plate 40 which is provided on one of the connection mechanisms 20 (the first connection mechanism 20A) enables the direction of movement of the slider 34 during flexion of the joint 12 to be reversed. Thus, as shown in FIG. 7, when the same screw shaft 28 is used (Examples 1 and 2), the winding direction of the element wire 55 in the first connection mechanism 20A is opposite to that of the element wire 55 in the second connection mechanism 20B.

The present invention has been described in terms of specific embodiments, but is not limited by such embodiments, and can be embodied with various modifications. Various changes may be made to features of the embodiments such as specific configuration, position, and quantity of each component or element thereof without departing from the scope of the present invention. Moreover, part or all features of the different embodiments may be combined with each other to yield another embodiment. In the above-described embodiments, not all elements included therein are essential, and some of them may be eliminated or replaced as appropriate.

Although, in the above-described embodiments, the reverser plate 40 is provided on one of the connection mechanisms 20, this feature is not essential. For example, when the first slider 34A and the first link 14A are directly connected to each other by a rod, the flexible shafts 50 with the element wires 55 wound in the same direction may be adopted for both the first drive mechanism 16A and the second drive mechanism 16B. In addition, the outer tube 52 is not essential in the flexible shaft 50. Furthermore, Although, in the above-described embodiments, the robot 1 uses the ball screws (linear reducers), the configuration of the robot 1 is not limited to such embodiment. In other cases, the robot 1 may use a rotary reducer.

In some cases, the robot 1 may be provided with a finger portion 4 that flexes when the flexible shafts 50 rotate in the direction that allows for a higher torsional stiffness thereof (first finger portion), and another type of finger portion 4 that flexes when the flexible shafts 50 rotate in the direction that provides low torsional stiffness (second finger portion). In such cases, the control device 17 may be connected to an external information acquisition device, such as a camera, that acquires external information, and set, based on the external information acquired by the external information acquisition device, an operation mode for grasping an object; that is, the control device 17 can set such a predetermined operation mode that allows the second finger portion to be used to grasp an object. For example, the control device 17 may set the operation mode to a second mode in which an object placed on the desk is grasped by using the second finger portion, when the height of the object placed on the desk is less than a predetermined height threshold. In this case, the control device 17 may set the operation mode to a first mode in which an object placed on the desk is grasped by using the first finger portion, when the height of the object placed on the desk is at or above the height threshold.

### Summary of Embodiments

The above-described embodiments of the present invention are summarized as follows.

One aspect of the present invention provides a transmission mechanism 26 which transmits torque from a drive device 22 to a joint 12 of a robot 1 such that the joint 12 flexes and extends in response to bidirectional torque output by the drive device 22, the transmission mechanism 26 comprising a flexible shaft 50 having flexibility, with an input side end 50P to which torque is input and an output side end 50Q from which torque is output, wherein the flexible shaft 50 has lower torsional stiffness in one rotational direction than in the other rotational direction, and transmits torque such that the joint 12 of the robot 1 flexes when the flexible shaft 50 rotates in the one rotational direction.

In this configuration, the joint 12 flexes when the flexible shaft 50 rotates in the direction which results in a lower torsional stiffness of the flexible shaft 50. This means that, when the load is applied to the robot 1 so as to resist its flexing operation, the flexible shaft 50 can be easily deformed, thereby absorbing the load. Accordingly, this configuration provides a transmission mechanism 26 that utilizes the torsional stiffness characteristics of the flexible shaft 50 that vary depending on the direction of the input torque, to reduce the negative effect of a load that hinders the robot's flexing operation.

Preferably, the above transmission mechanism is further configured such that the flexible shaft 50 comprises a plurality of winding layers 56 formed by the winding of element wires 55 in opposite winding directions alternately in consecutive layers, and wherein the element wire 55 forming the outermost layer is wound in the same direction as the other rotational direction.

This configuration can provide a flexible shaft 50 that has lower torsional stiffness in one rotational direction than in the other rotational direction.

Another aspect of the present invention provides a robot 1 with a joint 12, the robot 1 comprising: a drive device 22 that outputs bidirectional torque to flex and extend the joint 12; a displacement mechanism 39 that flexes the joint 12 when torque in one rotational direction is input from the drive device 22; and a flexible shaft 50 that connects the displacement mechanism 39 to the drive device 22, wherein the flexible shaft 50 comprises a plurality of winding layers 56 formed by the winding of element wires 55 in opposite winding directions alternately in consecutive layers, and wherein the element wire 55 forming the outermost layer of the flexible shaft 50 is wound in the same direction as the other rotational direction.

In this configuration, the joint 12 flexes when the flexible shaft 50 rotates in the direction which achieves a higher torsional stiffness of the flexible shaft 50. This means that, when the load is applied to the robot 1 so as to resist its flexing operation, the flexible shaft 50 can be easily deformed, thereby absorbing the load. Accordingly, this configuration provides a robot 1 that utilizes the torsional stiffness characteristics of the flexible shaft 50 that vary depending on the direction of the input torque, to reduce the negative effect of a load that hinders the robot's flexing operation.

Preferably, the above robot is further configured such that the displacement mechanism 39 comprises: a screw shaft 28 to which torque from the drive device 22 is input; a slider 34 that moves along an extending direction of the screw shaft 28 according to a direction in which the torque is input to the screw shaft 22; and a connection mechanism 20 that flexes the joint 12 when the slider 34 moves in a first direction along the extending direction of the screw shaft 28; wherein a thread direction of the screw shaft 28 is set such that, when torque is input in the one rotational direction, the slider 34 moves in the first direction.

This configuration enables a thread direction of the screw shaft 28 to be set such that the joint 12 flexes when the flexible shaft 50 rotates in the direction which results in a lower torsional stiffness of the flexible shaft 50.

Yet another aspect of the present invention provides a robot 1 with first and second joints 12A, 12B, the robot comprising: a first drive device 22A that outputs bidirectional torque to flex and extend the first joint 12A; a second drive device 22B that outputs bidirectional torque to flex and extend the second joint 12B; a first displacement mechanism 39A that flexes the first joint 12A when torque in one rotational direction is input from the first drive device 22A; a second displacement mechanism 39B that flexes the second joint 12B when torque in the other rotational direction is input from the second drive device 22B; a first flexible shaft 50A that connects the first displacement mechanism 39A to the first drive device 22A; and a second flexible shaft 50B that connects the second displacement mechanism 39B to the second drive device 22B, wherein each of the first flexible shaft 50A and the second flexible shaft 50B comprises a plurality of winding layers 56 formed by the winding of element wires 55 in opposite winding directions alternately in consecutive layers, wherein the element wire 55 forming the outermost layer of the first flexible shaft is wound in the same direction as the other rotational direction, and wherein the element wire 55 forming the outermost layer of the second flexible shaft 50B is wound in the same direction as the one rotational direction.

In this configuration, the joint 12 flexes when the flexible shaft 50 rotates in the direction which results in a lower torsional stiffness of the flexible shaft 50. This means that torque can be transmitted to counteract the load applied to the joint 12, enabling highly responsive finger flexing operation. Accordingly, this configuration provides a robot 1 that utilizes the torsional stiffness characteristics of the flexible shaft 50 that vary depending on the direction of the input torque.

1. A transmission mechanism which transmits torque from a drive device to a joint of a robot such that the joint flexes and extends in response to bidirectional torque output by the drive device, the transmission mechanism comprising:
a flexible shaft having flexibility, with an input side end to which torque is input and an output side end from which torque is output,
wherein the flexible shaft has lower torsional stiffness in one rotational direction than in the other rotational direction, and transmits torque such that the joint of the robot flexes when the flexible shaft rotates in the one rotational direction.

2. The transmission mechanism as claimed in claim 1, wherein the flexible shaft comprises a plurality of winding layers formed by the winding of element wires in opposite winding directions alternately in consecutive layers, and
wherein the element wire forming the outermost layer is wound in the same direction as the other rotational direction.

3. A robot with a joint, the robot comprising:
a drive device that outputs bidirectional torque to flex and extend the joint;
a displacement mechanism that flexes the joint when torque in one rotational direction is input from the drive device; and
a flexible shaft that connects the displacement mechanism to the drive device,
wherein the flexible shaft comprises a plurality of winding layers formed by the winding of element wires in opposite winding directions alternately in consecutive layers, and
wherein the element wire forming the outermost layer of the flexible shaft is wound in the same direction as the other rotational direction.

4. The robot as claimed in claim 3, wherein the displacement mechanism comprises:
a screw shaft to which torque from the drive device is input;
a slider that moves along an extending direction of the screw shaft according to a direction in which the torque is input to the screw shaft; and
a connection mechanism that flexes the joint when the slider moves in a first direction along the extending direction of the screw shaft;
wherein a thread direction of the screw shaft is set such that, when torque is input in the one rotational direction, the slider moves in the first direction.

5. A robot with first and second joints, the robot comprising:
a first drive device that outputs bidirectional torque to flex and extend the first joint;
a second drive device that outputs bidirectional torque to flex and extend the second joint;
a first displacement mechanism that flexes the first joint when torque in one rotational direction is input from the first drive device;
a second displacement mechanism that flexes the second joint when torque in the other rotational direction is input from the second drive device;
a first flexible shaft that connects the first displacement mechanism to the first drive device; and
a second flexible shaft that connects the second displacement mechanism to the second drive device,
wherein each of the first flexible shaft and the second flexible shaft comprises a plurality of winding layers formed by the winding of element wires in opposite winding directions alternately in consecutive layers,
wherein the element wire forming the outermost layer of the first flexible shaft is wound in the same direction as the other rotational direction, and
wherein the element wire forming the outermost layer of the second flexible shaft is wound in the same direction as the one rotational direction.
